(19) United States
(12) Patent Application Publication
(10) Pub. No.: US 2008/0186274 A1
(43) Pub. Date: Aug. 7, 2008

(54) METHOD FOR SELECTING DIGITAL FILES AND APPARATUS THEREOF

(75) Inventors: Chien-Chuan Chang, Taipei (TW); Ming-Huang Lin, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ULEAD SYSTEMS, INC., Taipei (TW)

(21) Appl. No.: 11/616,903

(22) Filed: Dec. 28, 2006

(30) Foreign Application Priority Data
Dec. 4, 2006 (TW) 95144936

(51) Int. Cl. G09G 5/00

(52) U.S. Cl. 345/156; 345/173

(57) ABSTRACT

A method for selecting digital files and an apparatus thereof are disclosed. In the present invention, a selection path is constructed by a user, and all digital files are selected according to the selection path. The construction of the selection path is achieved by using only one input interface, thus the convenience in digital file selection is greatly improved. Besides, all digital files corresponding to the selection path are selected at one time, thus, the purpose of speeding up the selection is also achieved.

### CROSS-REFERENCE TO RELATED APPLICATION

This application claims the priority benefit of Taiwan application serial no. 95144936, filed Dec. 4, 2006. All disclosure of the Taiwan application is incorporated herein by reference.

### BACKGROUND OF THE INVENTION

1. Field of the Invention

The present invention relates to a method for selecting digital files and an apparatus thereof. More particularly, the present invention relates to a method for selecting multiple digital files at a time and an apparatus thereof.

2. Description of Related Art

A user has to use both the mouse and the keyboard of a personal computer (PC) to select a plurality of digital files stored in that PC. For example, when the user is about to select a plurality of digital files from a folder window in the PC, first the user has to select one of the digital files by clicking at the digital file with the left button of the mouse, and then the user moves the mouse and clicks at another digital file while holding down the “Shift” key on the keyboard all the time. All continuous digital files between the two successively selected digital files are selected.

However, if the digital files the user wants to select are located discontinuously in the folder window, the mouse and the “Ctrl” key on the keyboard have to be used together to achieve this purpose. In other words, the user holds down the “Ctrl” key and meanwhile, continues to select other digital files in the folder window after the user has selected the first digital file by clicking the left button of the mouse. All the digital files clicked by the mouse while the “Ctrl” key is pressed down are selected for the user to perform subsequent operations.

Even though multiple digital files can be selected by using the methods described above, however, the mouse and the keyboard have to be used together to achieve foregoing purpose, which means the user has to operation with both hands, and in certain circumstances, which may cause inconvenience to the user. For example, when the user needs to receive instructions for file selection over a phone, the user has to operate the mouse and the keyboard while he/she is making the phone call. The possibilities of mistaken selection are increased under such circumstance. Besides, even though a plurality of digital files can be selected once with the mouse and the “Shift” key on the keyboard, only those continuous digital files in a window can be selected. When a user wants to select digital files at discontinuous positions, the user has to select many times by using the mouse and the “Ctrl” key on the keyboard together. In short, such method slows down the selection and makes the selection inflexible.

### SUMMARY OF THE INVENTION

Accordingly, the present invention is directed to a digital file selection method which not only speeds up the selection but also makes the selection very flexible.

According to another aspect of the present invention, an apparatus for selecting digital files is provided. With this apparatus, digital files can be selected flexibly and conveniently.

To achieve the aforementioned and other objectives, the present invention provides a digital file selection method which is suitable for selecting a plurality of digital files displayed in a user interface of an electronic apparatus. The method includes following steps. First, a path construction mode is entered. Next, a selection path is constructed according to the user's actions. The path construction mode is then exited. After that, digital files are selected according to the selection path.

According to the digital file selection method in an exemplary embodiment of the present invention, the method for entering the path construction mode includes receiving an initial command and entering the path construction mode from an operation mode of the electronic apparatus.

According to the digital file selection method in an exemplary embodiment of the present invention, the method for constructing the selection path according to the user's actions includes capturing an action track of the user and constructing the selection path according to the action track.

According to the digital file selection method in an exemplary embodiment of the present invention, the method for constructing the selection path further includes capturing a spatial position of the action track input by the user through an input interface and constructing the selection path corresponding to the spatial position.

According to the digital file selection method in an exemplary embodiment of the present invention, the input interface includes one of a mouse, an optical pen, a digital pen, a hand writing board, a trackball, a wireless input device, a touchpad, or a touch screen.

According to the digital file selection method in an exemplary embodiment of the present invention, the method for exiting the path construction mode includes receiving a termination command and returning from the path construction mode to the operation mode of the electronic apparatus.

According to the digital file selection method in an exemplary embodiment of the present invention, the method for selecting digital files according to the selection path further includes selecting those digital files the selection path passes through.

According to the digital file selection method in an exemplary embodiment of the present invention, the method for selecting digital files according to the selection path further includes determining whether or not the selection path includes a closed line and if so, selecting those digital files enclosed by the closed line.

According to the digital file selection method in an exemplary embodiment of the present invention, the selection path includes one of a straight line, a curve, or a closed line.

According to the digital file selection method in an exemplary embodiment of the present invention, the user interface includes one of a folder window, an application window, a touch screen, or a touchpad.

According to yet another aspect of the present invention, a digital file selection method suitable for selecting a plurality of digital files displayed in a user interface of an electronic apparatus is provided. The method includes following steps. First, a user inputs a selection path through an input interface, wherein the selection path includes a start point, a path, and an end point. Next, all digital files the selection path passes through are selected.

According to the digital file selection method in an exemplary embodiment of the present invention, the method for determining the start point of the selection path includes the user sending an initial message and transmitting the initial message to the electronic apparatus through the input interface.

According to the digital file selection method in an exemplary embodiment of the present invention, the method for determining the path of the selection path includes constructing the path corresponding to an action track of the user.

According to the digital file selection method in an exemplary embodiment of the present invention, the method for constructing the path further includes capturing a spatial position of the action track input by the user through the input interface and constructing the path corresponding to the spatial position.

According to the digital file selection method in an exemplary embodiment of the present invention, the method for determining the end point of the selection path includes the user sending a termination message and transmitting the termination message to the electronic apparatus through the input interface.

According to the digital file selection method in an exemplary embodiment of the present invention, the method for selecting digital files according to the selection path further includes selecting those digital files the selection path passes through.

According to the digital file selection method in an exemplary embodiment of the present invention, the method for selecting digital files according to the selection path further includes determining whether or not the selection path includes a closed line and if so, selecting those digital files enclosed by the closed line.

According to the digital file selection method in an exemplary embodiment of the present invention, the input interface includes one of a mouse, an optical pen, a digital pen, a hand writing board, a trackball, a wireless input device, a touchpad, or a touch screen.

According to the digital file selection method in an exemplary embodiment of the present invention, the user interface includes one of a folder window, an application window, a touch screen, or a touchpad.

According to yet another aspect of the present invention, a digital file selection apparatus is provided, which includes a display unit, an input interface, a selection path construction unit, and a file selection unit. The display unit is used for displaying a plurality of digital files. The input interface is used for inputting an initial message, an action track, and a termination message. The selection path construction unit is connected to the input interface and is used for constructing a selection path according to the initial message, the action track, and the termination message. The file selection unit is connected to the selection path construction unit and is used for selecting digital files according to the selection path.

According to the digital file selection apparatus in an exemplary embodiment of the present invention, the input interface includes one of a mouse, an optical pen, a digital pen, a hand writing board, a trackball, a wireless input device, a touchpad, or a touch screen.

According to the digital file selection apparatus in an exemplary embodiment of the present invention, the file selection unit further includes a position comparison module for comparing the selection path and the relative position of each digital file, so as to select specific digital files accordingly.

According to the digital file selection apparatus in an exemplary embodiment of the present invention, the file selection unit selecting the digital files further includes the file selection unit selecting those digital files the selection path passes through.

According to the digital file selection apparatus in an exemplary embodiment of the present invention, the file selection unit selecting the digital files further includes the file selection unit determining whether or not the selection path includes a closed line and if so, selecting those digital files enclosed by the closed line.

According to the present invention, a selection path is input by a user and digital files are selected according to the selection path. Accordingly, all the digital files are selected at a time regardless whether their positions are continuous or discontinuous, so that the selection efficiency is improved. Moreover, since the user can input the selection path by using only an input interface, complex operation is avoided and the selection of digital files is made very convenient and fast.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a method for selecting digital files according to an exemplary embodiment of the present invention.

FIG. 2 is a diagram of a folder window.

FIG. 3 is a flowchart illustrating a method for selecting digital files according to another exemplary embodiment of the present invention.

FIG. 4 is a diagram of a folder window.

FIG. 5 is a block diagram of an apparatus for selecting digital files according to yet another exemplary embodiment of the present invention.

FIG. 6 is a diagram of a folder window.

### DESCRIPTION OF EMBODIMENTS

These and other features, aspects, and advantages of the present invention will be described and become more apparent from the detailed description of exemplary embodiments when read in conjunction with accompanying drawings.

Usually a user has to use both a mouse and a keyboard to select a plurality of digital files in a user interface (such as a folder window) of an electronic apparatus (such as a personal computer, PC). However, the selection of the digital files will be more convenient if which can be done by simple operations such as using only the mouse or only the keyboard. Moreover, the selection operation will be made even more convenient if the user can select the digital files by simply touching a touchpad, for example. The present invention discloses a method for selecting digital files and an apparatus thereof based on such requirement.

FIG. 1 is a flowchart illustrating a method for selecting digital files according to an exemplary embodiment of the present invention. The detailed steps for selecting a plurality of digital files at the same time in the user interface of an electronic apparatus are described in the present embodiment. In the present embodiment, digital files may include any text, picture, music, or video/audio files which can be visually presented as thumbnails or icons, and the scope thereof is not limited herein. Referring to FIG. 1, first, the electronic apparatus has to enter a path construction mode before the user selects the digital files (step 110). The electronic apparatus may enter the path construction mode by receiving an initial command and then switching from an operation mode to the path construction mode. For example, the user may trigger the initial command by pressing down a mouse button, touching a specific area on a touchpad, or by giving a voice command to notice the electronic device.

Next, a selection path is constructed according to the user's actions (step 120). In an embodiment, the actions of the user produce an action track, and the selection path is constructed according to a spatial position corresponding to the action track captured by the input interface. For example, the user's actions may include moving the mouse or moving the touch after touching the touchpad etc. These movements in a 3D space are corresponded to spatial positions in a 2D space through the input interface for constructing the selection path. In the present embodiment, the input interface may be one of a mouse, an optical pen, a digital pen, a hand writing board, a trackball, a wireless input device (such as a wireless mouse etc.), a touchpad, or a touch screen, and the scope thereof is not limited herein. The selection path constructed according to the user's actions may include a straight line, a curve, a zigzag line, or a closed line (such as an elliptical line or the combination of the sidelines of a polygon etc.), and the scope thereof is not limited herein either.

After the selection path has been constructed, the electronic apparatus exits the path construction mode and returns to the operation mode (step 130), wherein the electronic apparatus exits the path construction mode when it receives a termination command triggered by the user. In an embodiment of the present invention, the user triggers the termination command by releasing the mouse button, withdrawing the touch from the specific area on the touchpad, or by giving a voice command to notice the electronic device to exit the path construction mode.

Finally, digital files are selected according to the selection path in step 140. In an embodiment of the present invention, all digital files corresponding to the thumbnails or icons the selection path (including a straight line, a curve, or a closed line etc.) passes through are selected. While in another embodiment of the present invention, whether or not the selection path includes a closed line is determined, and if the selection path includes a closed line (a closed line can be formed when the path of the selection path crosses itself, such as an elliptical line or the combination of the sidelines of a polygon), only those digital files corresponding to the thumbnails or icons which are completely enclosed by the closed line in the selection path are selected, while those digital files corresponding to the thumbnails or icons the selection path (including the closed line itself) passes through will not be selected. In yet another embodiment of the present invention, if the selection path includes a closed line (for example, an elliptical line), those digital files corresponding to the thumbnails or icons the closed line passes through, and those digital files corresponding to the thumbnails or icons enclosed by the closed line (i.e. located within the closed line) are all selected.

In the embodiment described above, the electronic apparatus may include a PC, a mobile phone, a smart phone, a PDA, a palmtop play station (such as PSP/GBA), a MP4/PMP player, a digital camera, a tablet PC, or a notebook computer, and the scope thereof is not limited herein. The user interface may include one of a folder window, an application window, a touch screen, or a touchpad, and the scope thereof is not limited herein either.

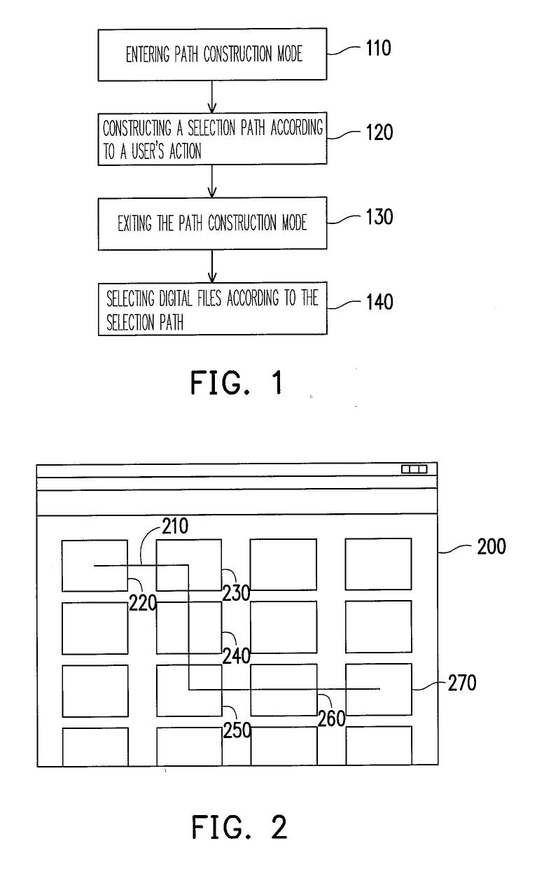

To be more specific, the selection of a plurality of picture files in a folder window of a PC is described according to an embodiment of the present invention. In the present embodiment, the user triggers an initial command by pressing down the left button of the mouse. The CPU of the PC enters a path construction mode after receiving the initial command. Here the user constructs the selection path by pressing down the left button of the mouse and dragging the mouse at the same time. After the selection path has been constructed, the user releases the left button of the mouse to trigger a termination command so that the PC exits the path construction mode. As shown in FIG. 2, the picture files 220, 230, 240, 250, 260, and 270 which the selection path 210 passes through are all selected after the PC exits the path construction mode.

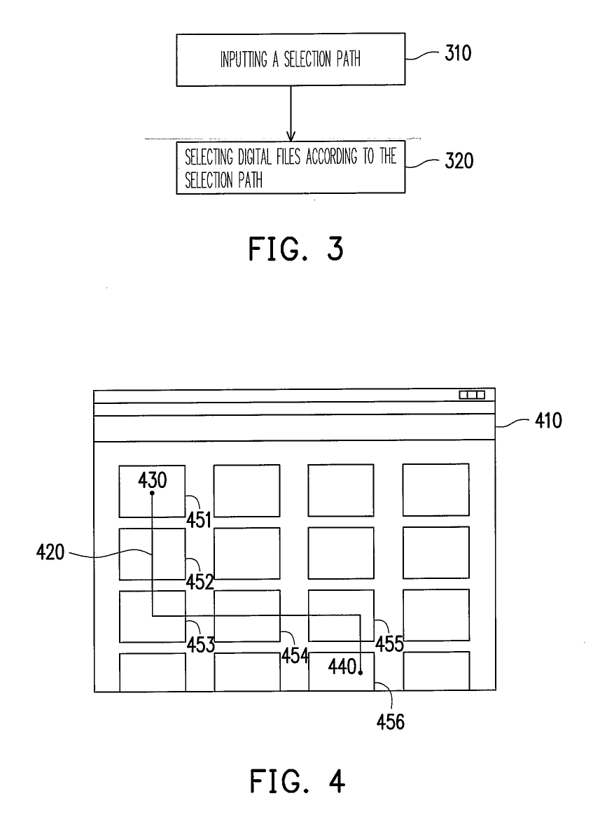

FIG. 3 is a flowchart illustrating a method for selecting digital files according to another exemplary embodiment of the present invention. The detailed steps for selecting a plurality of digital files displayed in a user interface of an electronic apparatus is described in the present embodiment. The user interface may include one of a folder window, an application window, a touch screen, or a touchpad. Referring to FIG. 3, a user inputs a selection path through an input interface in step 310. The selection path includes a start point, a path, and an end point. In the present embodiment, the input interface may include one of a mouse, an optical pen, a digital pen, a hand writing board, a trackball, a wireless input device (such as a wireless mouse), a touchpad, or a touch screen, and the scope thereof is not limited herein. The start point of the selection path is determined, for example, when the user sends an initial message (for example, by pressing down a mouse button or touching a touch screen) which transmits the initial message to the electronic apparatus through the input interface. Next, the electronic apparatus captures a spatial position of an action track input by the user through the input interface and constructs the path of the selection path corresponding to the spatial position. Finally, the electronic apparatus receives a termination message input by the user (for example, by releasing the mouse button or withdrawing the touch from the touch screen) to determine the end point of the selection path.

Digital files are then selected according to the selection path input by the user in step 320, wherein digital files which the selection path passes through may be selected, or whether or not the selection path includes a closed line may be determined and if so, those digital files enclosed by the closed line are selected. For example, in an embodiment, only those digital files corresponding to the thumbnails or icons which are completely enclosed by the closed line (i.e. located inside the closed line completely) are selected. While in another embodiment, digital files corresponding to the thumbnails or icons which are completely enclosed by the closed line or that passing through are all selected.

In the present embodiment, digital files may include any text, picture, music, or video/audio files which can be presented visually as icons or thumbnails, and the scope thereof is not limited herein.

The selection of a plurality of video/audio files from a folder window in a PC will be described below according to an embodiment of the present invention. Referring to FIG. 4, the user may use a mouse for inputting a selection path after the user has opened the folder window 410 and decided which video/audio files are to be selected. For example, after the user presses down the left button of the mouse, the electronic apparatus may determine the current position of the cursor as the start point 430. Next, the user drags the mouse while pressing down the left button of the mouse, as to input the path. Eventually, the user inputs the end point 440 by releasing the left button of the mouse. Accordingly, the user inputs the selection path 420 by using the mouse. The video/audio files 451, 452, 453, 454, 455, and 456 in the folder window 410 which the selection path 420 passes through are all selected for the user to perform subsequent operations (for example, open, move, copy, or delete etc.).

In the present embodiment, the user may also input audio messages for determining the start point and end point of the selection path, and then determine the path of the selection path by dragging the mouse so as to complete the input of the selection path.

In another embodiment of the present invention, an optical pen or other computer peripheral equipment is further used for inputting the selection path. The operation of an optical pen is very similar to that of a mouse. A user presses down the tip of the optical pen to input the start point of a selection path, then moves the optical pen with the tip pressed down to input the path, and eventually releases the tip of the optical pen to input the end point, so as to complete the input of the selection path.

Moreover a touchpad or even a touch screen may also be used for inputting a selection path. Any other peripheral equipment which can input messages into an electronic apparatus (for example, rocker rod, hand writing board, digital pen, wireless input device such as wireless mouse, or trackball etc.) may be used as the input interface and the scope thereof is not limited herein.

In the embodiments described above, the selection path input by the user may include a straight line, a curve, or a closed line (for example, an elliptical line or the combination of all the sidelines of a polygon), and the scope thereof is not limited herein.

As described above, the user can input a selection path by using only one input interface, and a plurality of files are selected at one time according to the selection path, thus, the digital file selection method in the present invention is more convenient than conventional techniques.

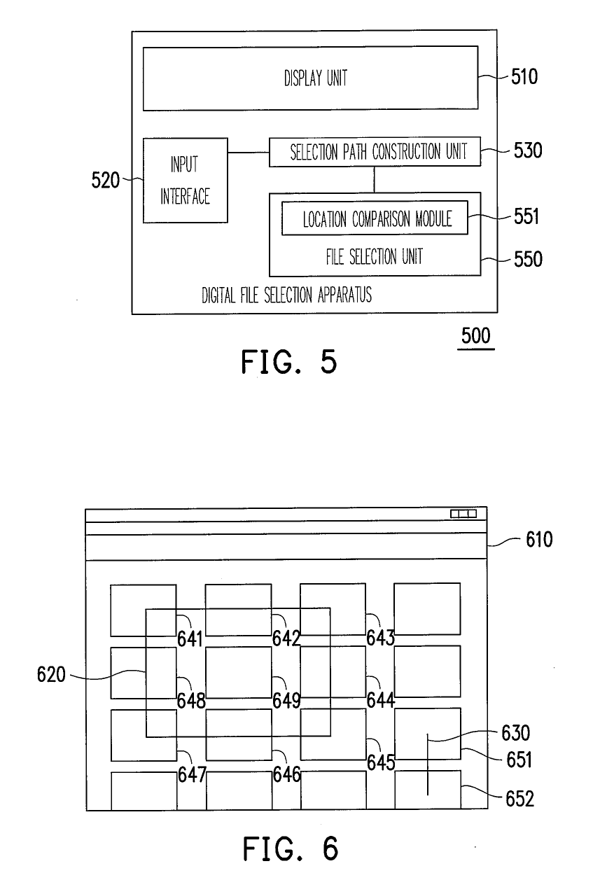

FIG. 5 is a block diagram of an apparatus for selecting digital files according to yet another exemplary embodiment of the present invention. Referring to FIG. 5, the digital file selection apparatus 500 includes a display unit 510, an input interface 520, a selection path construction unit 530, and a file selection unit 550. The display unit 510 is used for displaying digital files.

The input interface 520 is suitable for inputting an initial message, an action track, and a termination message, wherein the initial message is used for prompting the electronic apparatus to get ready for entering the path construction mode, the action track is produced corresponding to the user's actions, and the termination message is used for prompting the electronic apparatus to get ready for exiting the path construction mode. In the present embodiment, the input interface 520 may be any input device such as a mouse, an optical pen, a digital pen, a hand writing board, a trackball, a wireless input device (such as a wireless mouse), a touchpad, or a touch screen, etc., and which is not limited thereto.

The selection path construction unit 530 is connected to the input interface 520 and constructs a selection path according to the action track between the receptions of the initial message and the termination message. The selection path may be a straight line, a curve, or a closed line etc.

The file selection unit 550 is connected to the selection path construction unit 530 and is suitable for selecting digital files according to the selection path constructed by the selection path construction unit 530. In the present embodiment, the file selection unit 550 further includes a position comparison module 551 which is suitable for comparing the selection path and the relative position of each digital file, so as to determine the relationships between the selection path and these digital files and further to assist the file selection unit 550 to select these digital files. In an embodiment of the present invention, the file selection unit 550 selects those digital files the selection path passes through. While in another embodiment of the present invention, the file selection unit 550 determines whether or not the selection path includes a closed line, and if so, only those digital files which are completely enclosed by the closed line are selected, but those digital files the closed line passes through won't be selected. In yet another embodiment of the present invention, all the digital files enclosed by the closed line or that passing through are selected.

In the present embodiment, the detailed procedure of selecting digital files by using the digital file selection apparatus 500 is similar to that in foregoing embodiment, therefore which will not be described herein.

It should be mentioned here that besides inputting one selection path through a single input interface, the user may also use other input interfaces (such as a keyboard) at the same time for inputting a plurality of selection paths and selecting those digital files all the selection paths pass through or digital files enclosed by all closed paths. Referring to FIG. 6, in the present embodiment, it is assumed that a plurality of picture files are to be selected in a folder window 610 and all digital files completely enclosed by a closed line and digital files the closed line passes through are selected when the selection path is a closed line. First, the user inputs a selection path 620 in the folder window 610 with a mouse. Next, the user holds down a key (for example, the “Ctrl” key) on the keyboard and at the same time, inputs a second selection path 630 with the mouse. The user releases the “Ctrl” key until no more picture file is to be selected. When a selection path is determined to include a closed line (the selection path 620), picture files the selection path 620 passes through (i.e. picture files 641, 642, 643, 644, 645, 646, 647, and 648), picture file 649 which is completely enclosed by the selection path 620, and picture files 651 and 652 the selection path 630 passes through are all selected for the user to open, copy, move, or delete.

In the present embodiment, the user inputs two selection paths for selecting digital files with the assistance of the keyboard. However, actually the user can input a plurality of selection paths or single-click at digital files at the same time while pressing down the “Ctrl” key according to the user's own requirement, so that those digital files passed through or enclosed by all the selection paths input by the user and those digital files clicked by the user are selected all together. The selection of digital files is made very flexible regardless of one or more selection paths are input.

In summary, the digital file selection method in the present invention has at least following advantages:
1. a user can input a selection path for selecting a plurality of digital files by using only one input interface, thus, the convenience in digital file selection is greatly improved.
2. by constructing a selection path, all related digital files are selected at one time according to the selection path, so that the selection of digital files is sped up.
3. digital files are selected at one time according to a selection path input by the user regardless whether they are located continuously or discontinuously in the user interface, so that the selection of digital files is made very flexible.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for selecting digital files, suitable for selecting a plurality of digital files displayed in a user interface of an electronic apparatus, the method comprising:
entering a path construction mode;
constructing a selection path according to actions of a user;
exiting the path construction mode; and
selecting the digital files according to the selection path.

2. The digital file selection method as claimed in claim 1, wherein the method for entering the path construction mode comprises:
receiving an initial command, to enter the path construction mode from an operation mode of the electronic apparatus.

3. The digital file selection method as claimed in claim 1, wherein the method for constructing the selection path according to the actions of the user comprises:
capturing an action track of the user, to construct the selection path.

4. The digital file selection method as claimed in claim 3, wherein the method for constructing the selection path further comprises:
capturing a spatial position of the action track input by the user through an input interface, constructing the selection path corresponding to the spatial position.

5. The digital file selection method as claimed in claim 4, wherein the input interface comprises one of a mouse, an optical pen, a digital pen, a hand writing board, a trackball, a wireless input device, a touchpad, or a touch screen.

6. The digital file selection method as claimed in claim 1, wherein the method for exiting the path construction mode comprises:
receiving a termination command, to return to the operation mode of the electronic apparatus from the path construction mode.

7. The digital file selection method as claimed in claim 1, wherein the method for selecting the digital files according to the selection path further comprises:
selecting the digital files the selection path passes through.

8. The digital file selection method as claimed in claim 1, wherein the method for selecting the digital files according to the selection path further comprises:
determining whether or not the selection path comprises a closed line; and
selecting the digital files enclosed by the closed line if the selection path comprises the closed line.

9. The digital file selection method as claimed in claim 1, wherein the selection path comprises one of a straight line, a curve, or a closed line.

10. The digital file selection method as claimed in claim 1, wherein the user interface comprises one of a folder window, an application window, a touch screen, or a touch pad.

11. A method for selecting digital files, suitable for selecting a plurality of digital files displayed in a user interface of an electronic apparatus, the method comprising:
a user inputting a selection path through an input interface, wherein the selection path comprises a start point, a path, and an end point; and
selecting the digital files according to the selection path.

12. The digital file selection method as claimed in claim 11, wherein the method for determining the start point comprises:
the user sending an initial message and transmitting the initial message to the electronic apparatus through the input interface.

13. The digital file selection method as claimed in claim 11, wherein the method for determining the path comprises:
constructing the path corresponding to an action track of the user.

14. The digital file selection method as claimed in claim 13, wherein the method for constructing the path further comprises:
capturing a spatial position of the action track input by the user by using the input interface, constructing the path corresponding to the spatial position.

15. The digital file selection method as claimed in claim 11, wherein the method for determining the end point comprises:
the user sending a termination message and transmitting the termination message to the electronic apparatus through the input interface.

16. The digital file selection method as claimed in claim 11, wherein the method for selecting the digital files according to the selection path further comprises:
selecting the digital files the selection path passes through.

17. The digital file selection method as claimed in claim 11, wherein the method for selecting the digital files according to the selection path further comprises:
determining whether or not the selection path comprises a closed line; and
selecting the digital files enclosed by the closed line if the selection path comprises the closed line.

18. The digital file selection method as claimed in claim 11, wherein the input interface comprises one of a mouse, an optical pen, a digital pen, a hand writing board, a trackball, a wireless input device, a touchpad, or a touch screen.

19. The digital file selection method as claimed in claim 11, wherein the user interface comprises one of a folder window, an application window, a touch screen, or a touchpad.

20. An apparatus for selecting digital files, comprising:
a display unit, for displaying a plurality of digital files;
an input interface, for inputting an initial message, an action track, and a termination message;
a selection path construction unit, connected to the input interface, the selection path construction unit being suitable for constructing a selection path according to the initial message, the action track, and the termination message; and
a file selection unit, connected to the selection path construction unit, the file selection unit being suitable for selecting the digital files according to the selection path.

21. The digital file selection apparatus as claimed in claim 20, wherein the input interface comprises one of a mouse, an optical pen, a digital pen, a hand writing board, a trackball, a wireless input device, a touchpad, or a touch screen.

22. The digital file selection apparatus as claimed in claim 20, wherein the file selection unit further comprises:
a position comparison module, suitable for comparing the selection path and a relative position of each of the digital files, so as to select specific digital files from the digital files.

23. The digital file selection apparatus as claimed in claim 20, wherein the file selection unit selecting the digital files further comprises the file selection unit selecting the digital files the selection path passes through.

24. The digital file selection apparatus as claimed in claim 20, wherein the file selection unit selecting the digital files farther comprises the file selection unit determining whether or not the selection path comprises a closed line and selecting the digital files enclosed by the closed line if the selection path comprises the closed line.
